(19) United States
(12) Patent Application Publication
(10) Pub. No.: US 2011/0301859 A1
(43) Pub. Date: Dec. 8, 2011

(54) PERSONALIZED MOLECULAR MEDICINE

(75) Inventors: Jennifer L. Carter, Lexington, MA (US); Sheryl Krevsky Elkin, Arlington, MA (US); Jo-Ellen Murphy, Grove, NJ (US)

(73) Assignee: N-OF-ONE THERAPEUTICS, INC., Lexington, MA (US)

(21) Appl. No.: 13/151,830

(22) Filed: Jun. 2, 2011

Related U.S. Application Data
(60) Provisional application No. 61/351,654, filed on Jun. 4, 2010.

(51) Int. Cl. G06F 19/10

(52) U.S. Cl. 702/19

(57) ABSTRACT

A computer based system and methods for generating and outputting information relating to personalized therapy, including diagnosis and/or treatment is described herein.

### CROSS-REFERENCE TO RELATED APPLICATION

This application claims priority to U.S. Provisional application Ser. No. 61/351,654, filed on Jun. 4, 2010, entitled “The N-of-One Knowledge Base: A centralized Knowledge Base for Personalized Molecular Medicine and Clinical Knowledge,” the entire contents of which is hereby incorporated by reference.

### TECHNICAL FIELD

A computer-based system configured to organize, analyze, and distribute information related to personalized medical consultation and treatment strategy to patients, their physicians and/or other healthcare entities is described herein.

### BACKGROUND

Cancer affects millions of people each year. Annually, about 1.4 million people are diagnosed with cancer in the United States. On average, sixteen million Americans live with cancer each day. Of these, about one half million will die annually. Yet, each case is exceedingly personal. Cancer research has shown that a cancer that affects one person is often quite different from a cancer that affects another person. Even in the same organ or within a single patient, cancer cells can be dramatically different at the molecular level due to differences in each individual's tumor genetics.

Until recently, traditional cancer treatments have been based on the results of clinical trials with “large N's,” the trial vernacular for large “numbers” of patients. However, such an approach may not always be appropriate for many of the individuals who suffer from cancer. In particular, each tumor/cancer has its own unique genetic and molecular signature, which explains why in certain instances, patients with the same type of cancer often experience dramatic differences in their response to chemotherapy or treatment. Recent advances in the study of tumor biology have allowed for greater molecular insight into the tumor biology within individual patients, leading to treatments that can prolong and even save lives.

Unfortunately, the analysis of the genetic and molecular signature of tumors can be complex, time consuming and costly; and this analysis is often not part of the current standard of care. As a result, many patients are never able to benefit from the latest scientific diagnostic and treatment discoveries that could significantly affect their disease course.

Moreover, significant barriers exist that have prevented scientific understanding of tumor biology from being used to inform treatment. These include regulatory constraints on making diagnostic claims for molecular markers (e.g., any underlying molecular driver of the tumor cell including genetic mutations, amplification, deletions, and alterations; and biomarkers including all changes in proteins, enzymes and other cellular signals) that have not been validated through clinical trials, and a medical reimbursement system that does not compensate physicians for the time it takes to design and implement highly individualized treatment strategies.

### SUMMARY

A computer based system for generating and outputting information relating to personalized cancer therapy, including diagnosis and treatment is described herein. The system includes a database that includes information about molecular markers for various types of cancer, rationales for testing (including literature references), testing laboratories, drugs associated with the molecular markers, and clinical trials testing new drugs is in the process of development. Based on the information in the database, hospitals/physicians, can input their patient's medical history and obtain, in an automated fashion, a set of suggested diagnostic tests that could be beneficial to the patient. Upon completion of diagnostic testing, the patient's record can be updated with the test results, and a set of recommendations related to treatment is automatically generated by the computer system, e.g., detailing potential treatments or clinical trials that could be applicable, based on the patient's molecular profile.

In some aspects, a computer-implemented method includes receiving, by one or more computers, patient information including disease identification information. The method also includes receiving, by the one or more computers, tissue assessment information related to tissue available for testing. The method also includes accessing, by the one or more computers, a database that includes information related to biomarkers and tissue testing to generate a set of potential diagnostic tests, the set of potential diagnostic tests being based in part on the disease identification information. The method also includes providing information related to at least some of the potential diagnostic tests in the set of potential diagnostic tests to a user.

Embodiments may include one or more of the following.

The method can also include ranking, by the one or more computers, the set of potential diagnostic tests based on one or more of a likelihood of a biomarker associated with a particular diagnostic test being present in tissue, availability of treatment based on biomarker associated with the particular diagnostic test, and an amount of tissue required for the particular diagnostic test.

The method can also include filtering, by the one or more computers, the set of potential diagnostic tests based on the ranking.

Filtering the set of potential diagnostic tests can include filtering the set of potential diagnostic tests based on the tissue assessment information and providing information related to at least some of the potential diagnostic tests to the user comprises providing the filtered set of potential diagnostic tests.

Providing information related to at least some of the potential diagnostic tests to the user can include generating a diagnostic strategy roadmap.

Providing information related to at least some of the potential diagnostic tests can include providing a list of suggested diagnostic tests, an explanation of the rationale for testing a biomarker, a list of drugs for a particular biomarker, and a list of references related to a biomarker.

In some aspects, a system can include a database configured to store patient information including disease identification information and tissue assessment information related to tissue available for testing. The system can also include one or more computers configured to access the database that includes information related to biomarkers and tissue testing to generate a set of potential diagnostic tests, the set of potential diagnostic tests being based in part on the disease identification information and provide information related to at least some of the potential diagnostic tests in the set of potential diagnostic tests to a user.

Embodiments can include one or more of the following.

The one or more computers can be further configured to rank the set of potential diagnostic tests based on one or more of a likelihood of a biomarker associated with a particular diagnostic test being present in tissue, availability of treatment based on biomarker associated with the particular diagnostic test, and an amount of tissue required for the particular diagnostic test and filter the set of potential diagnostic tests based on the ranking.

The configurations to filter the set of potential diagnostic tests can include configurations to filter the set of potential diagnostic tests based on the tissue assessment information and the configurations to provide information related to at least some of the potential diagnostic tests to the user comprise configurations to provide the filtered set of potential diagnostic tests.

The configurations to provide information related to at least some of the potential diagnostic tests to the user can include configurations to generate a diagnostic strategy roadmap.

In some aspects, a computer-implemented method includes receiving, by one or more computers, patient information including disease identification information. The method also includes receiving, by the one or more computers, information based on biomarker testing results. The method also includes accessing, by the one or more computers, a database that includes information related to drugs, clinical studies, and other treatment options associated with biomarker information to generate a set of treatment options. The method also includes providing information related to at least some of the treatment options in the set of treatment options to a user.

Embodiments can include one or more of the following.

The method can also include for each of the treatment options in the set of treatment options, assigning, by the one or more computers, a score associated with a validity and stage of testing of the treatment and ranking, by the one or more computers, the treatment options in the set of treatment options based on the assigned scores.

Providing information related to at least some of the treatment options can include generating a treatment strategy roadmap.

The information related to at least some of the treatment options can include information associated with currently approved drugs and clinical trials based on a molecular profile of a tumor in the patient.

Providing information related to at least some of the treatment options can include providing information related to available drugs associated with a biomarker and ongoing clinical studies associated with the biomarker.

In some aspects, a system can include a first database configured to store patient information including disease identification information and information based on biomarker testing results and a second database that includes information related to drugs, clinical studies, and other treatment options associated with biomarker information to generate a set of treatment options. The system can also include one or more computers configured to access the database that includes information related to drugs, clinical studies, and other treatment options associated with biomarker information to generate a set of treatment options based on one or more of the patient information and the information based on biomarker testing results and provide information related to at least some of the treatment options in the set of treatment options to a user.

Embodiments can include one or more of the following.

The one or more computers can be further configured to for each of the treatment options in the set of treatment options, assign, by the one or more computers, a score associated with a validity and stage of testing of the treatment and rank the treatment options in the set of treatment options based on the assigned scores.

The configurations to provide information related to at least some of the treatment options can include configurations to generate a treatment strategy roadmap.

The information related to at least some of the treatment options can include information associated with currently approved drugs and clinical trials based on a molecular profile of a tumor in the patient.

The database can be further configured to store tissue assessment information related to tissue available for testing.

In some additional aspects, a computer program product tangibly embodied on a computer readable medium can include instructions to cause one or more processors to perform the methods described herein.

The one or more computers can be further configured to access the database that includes information related to biomarkers and tissue testing to generate a set of potential diagnostic tests, the set of potential diagnostic tests being based in part on the disease identification information and provide information related to at least some of the potential diagnostic tests in the set of potential diagnostic tests to a user.

### BRIEF DESCRIPTION OF DRAWINGS

FIG. 1 is a flow chart of a computer implemented process for identifying diagnostic tests and providing potential treatment options.

FIG. 2 is a schematic diagram of a computer system including a diagnostic and treatment database.

FIG. 3 is a schematic representation of information included in a patient data record.

FIG. 4 shows an exemplary screen shot of a patient page.

FIG. 5 shows an exemplary screen shot of a patient section.

FIG. 6 shows an exemplary screen shot of a disease information section.

FIG. 7 illustrates an overview of the diagnostic and treatment database, including inputs and outputs for generating a diagnostic strategy roadmap.

FIG. 8 is a flow chart of a process for generating a diagnostic strategy roadmap.

FIG. 9 is an exemplary diagnostic strategy roadmap.

FIG. 10 illustrates an overview of the diagnostic and treatment database, including inputs and outputs for generating a treatment strategy roadmap.

FIGS. 11A-11D show an example of a treatment strategy roadmap.

FIG. 12 is a flow chart of a process for generating a treatment strategy roadmap.

FIG. 13 is an example of a treatment prioritization structure.

FIG. 14 is a schematic diagram of a computer system.

### DESCRIPTION

Since medical research has shown that cancer is an individual disease, it can be advantageous to provide a systematic, computer-based approach that focuses on each patient individually, from diagnosis to treatment delivery. Described herein is a computer-based system that provides a centralized resource where physicians can quickly and easily access up-to-the-minute information about molecular markers, leading-edge testing laboratories, new drugs, clinical trials, and the world's top cancer experts in order to identify and personalize treatments that may not otherwise be considered. The system analyzes information and automatically provides information about suggested testing and treatments based on the stored information in conjunction with patient specific data. Additionally, in some aspects, the system can include a computer-based portal to enable patients to learn about molecular diagnostics, input questions, receive updates and information, and view their diagnostic and treatment strategies. Thus, the systems described herein can provide the advantage of enabling patients and their medical teams to access the latest scientific diagnostic and treatment discoveries.

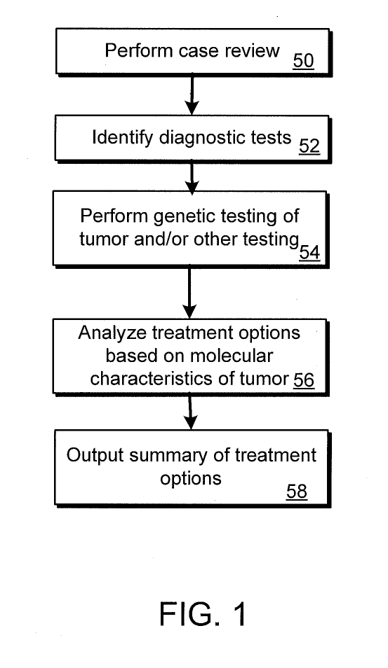

FIG. 1 shows a flow chart of a process performed at least in part by a computer system for identifying diagnostic tests and providing potential treatment options. The process shown in FIG. 1 can provide a highly customized approach to testing and treatment for individuals who are battling an active cancer, monitoring for recurrence or concerned about their risk of cancer because of personal or family history. Additionally or alternatively, the processes described in FIG. 1 can be applied to other diseases.

The process includes performing a thorough review of a patient's case and inputting and storing data about the patient, their disease, prior treatments, and the like into the computer system (box 50). As described in greater detail herein, the system includes a database of information about diseases, diagnostics, and treatments much of which is related to the specific molecular characteristics of different types and forms of cancer. Based on a combination of the information about the patient and information about diagnostics, the computer-based system automatically identifies diagnostic tests that could be beneficial in diagnosis and treatment of the patient (box 52). For example, the diagnostic tests can include diagnostic tests that may help a patient's doctor to learn more about the biology of their patient's tumor. The process also includes receiving results from genetic testing of the tumor or other testing (box 54). The testing is performed by a medical facility based on the testing suggestions generated by the system. Based on the received results, the computer based system analyzes both standard and cutting edge therapies that may be relevant for the patient and identifies treatment strategies that are tailored for the specific molecular characteristics of the patient's cancer (box 56). These results are outputted to the patient and doctor in an easy to understand summary form (box 58). The output can include displaying the treatment summary on a user interface, printing the summary, e-mailing the summary, and the like.

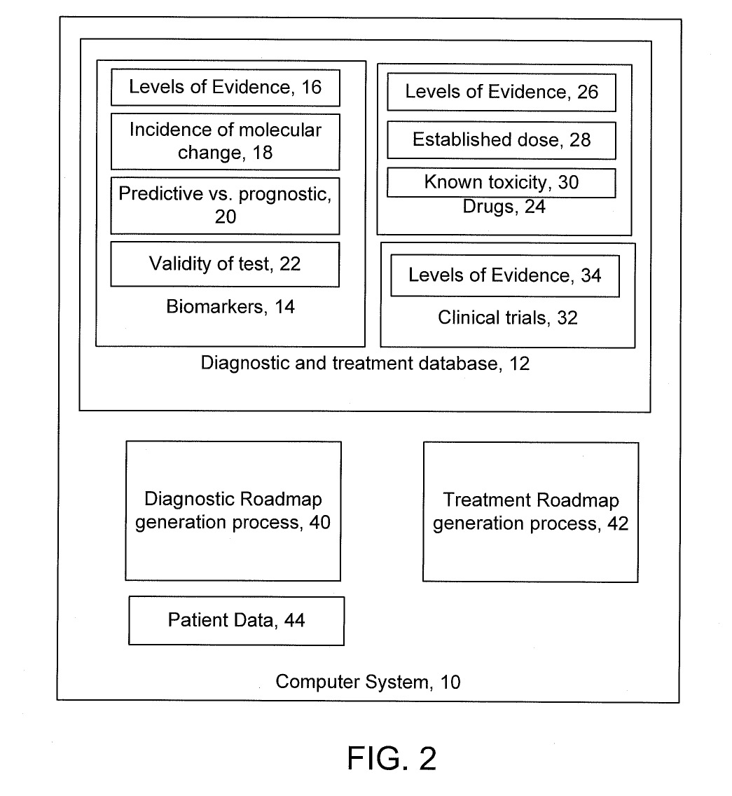

As noted above, the computer-based system includes a database of information accessed to determine diagnostic and treatment options for a patient. FIG. 2 shows an exemplary diagnostic and treatment database 12 (also referred to herein as a knowledge base) stored in a memory on a computer system 10. Diagnostic and treatment database 12 can be a relational knowledge base for the storage, editing, and sharing of information related to personalized treatment for patients battling cancer. The process for aggregating molecular oncology information into the diagnostic and treatment database 12 can involve working closely with patients, their physicians, diagnostic laboratories, and cancer thought-leaders throughout the world. The diagnostic and treatment database 12 integrates data on individual cancer histories, molecular profiles, diagnostic molecular markers, and treatment outcomes. In some aspects, the database can also include review and annotation of the data for clinical relevance and scientific validity, and captures that knowledge into a shared resource. In some examples, the resulting Knowledge Base can be embedded in a “Molecular Oncology Web” community.

The diagnostic and treatment database 12 is configured to accept multiple different types of information from multiple input sources. System 10 can also include a diagnostic roadmap generation process 40 and a treatment roadmap generation process 42 that process and synthesize information from the database 12 to provide decision-making assistance to physicians and patients regarding the most appropriate diagnostic tests and treatments for the patient's particular cancer. In addition to accessing the information in the diagnostic and treatment database 12 the diagnostic roadmap generation process 40 and treatment roadmap generation process 42 can access patient data 44 which is also stored in a memory associated with the computer system 10.

In general, each cancer type will have an associated list of molecular markers that are relevant for testing in a patient who was diagnosed with that type of cancer. Thus, it can be beneficial to include information related to biomarkers 14 in the diagnostic and treatment database 12. Each molecular marker will be defined and can have an accompanying rationale for testing in that cancer type, supported by evidence from the medical and scientific literature. Literature references will be linked to the external site “PubMed,” (a public database supported by the National Institute of Health) such that clicking on a reference of interest would link the user to the PubMed page for that scientific reference. In some examples, the selection of molecular markers for each disease, the rationale for testing, and the appropriate literature references can be entered by a scientific team, in consultation with experts in the field.

Each molecular marker will also be associated with a list of relevant drugs 24. The list will be inclusive of drugs that are FDA-approved, in clinical trials, or in preclinical development. For each drug listed, information will be included detailing its mechanism of action, its target gene or protein, the indications for which it has been approved or in which it is being tested, the stage of development, level of evidence 26, established dose 28, and any known toxicities 30.

Additional sources of data input may include guidelines from the National Comprehensive Cancer Network (NCCN), which is free to registered users, as well as other public, or potentially private, sources of data and information on therapeutic options.

The diagnostic and treatment database 12 can also include a vetted list of diagnostic laboratories that provide testing for the molecular markers. Prior to inclusion in the diagnostic and treatment database 12, each laboratory would be carefully investigated to verify that the tests offered are properly validated and reliable. Information for each laboratory will be provided including: the specific tests offered, technology utilized, methods of validation, relevant publications, tissue requirements and protocols, requisitions, and contact information. A portal to the diagnostic and treatment database 12 will be available for the contracted diagnostic laboratories in order for them to input their information directly with consultation from scientists. The laboratories can maintain their list of available diagnostic testing, tissue requirements, changes in regulatory status, test validation studies, reagent specifications, requisitions, contact information, packaging and shipping details, and any other relevant information. This procedure will ensure that the information regarding available tests and protocols would always be up-to-date and accurate in database 12.

In some examples, the information related to the biomarkers 14 included in the diagnostic and treatment database 12 can include information on levels of evidence 16, information on incidence of molecular change 18, predictive versus prognostic information 20, and information about the validity of test 22. In general the levels of evidence 16 relate to the value of the studies used to test drugs or evaluate the utility of a molecular marker and can include information such as number of patients in a clinical trial, randomization, and trial design. In general, the incidence of molecular change 18 relates to how frequently a particular molecular change is detected with respect to a given population and can include information such as percentage of tumors containing that molecular change. The indication of whether a biomarker is predictive or prognostic 20 provides information about whether the presence or absence of a biomarker can predict a response to a drug (predictive) or whether the biomarker predicts a disease outcome irrespective of a therapy (prognostic). The information about the validity of the test 22 relates to the methods used to ensure that the test is reliable and can include information such as what measures were taken to determine that a test's determination of mutation, gene amplification, protein expression, or gene expression can be relied upon to be correct, including clinical trials in which the test was utilized.

The diagnostic and treatment database 12 also includes a list of current clinical trials 32. Sources for the clinical trial information will include the following external sites: the NIH (ClinicalTrials.gov), the NCI (cancer.gov/clinicaltrials), and those of trial sponsors such as the pharmaceutical and biotechnology companies and the academic institutions and principal investigators. Available information will include the drug(s) being tested, mechanism of action, disease type, eligibility information, biomarker testing requirements and/or associations, rationale for development, location of the trial, and sponsor, in addition to other relevant information specific to each individual trial. Results of previous clinical trials for the relevant drugs will also be accessible for review. Biotechnology and pharmaceutical companies, academic institutions, hospitals and individual investigators will be able to subscribe to the diagnostic and treatment database 12 in order to have their trial information listed and maintained. This information will be accessed by the computer system to automatically create the treatment strategy roadmaps that are provided as a service to clients, as described in more detail herein.

A portal for entering information into the diagnostic and treatment database 12 will also be open to Oncology Council members and contributing experts. Thought-leading physicians and scientists from around the world on particular types of cancer, or areas of cancer biology and related sciences can contribute directly to the diagnostic and treatment database 12, annotating information about drugs, molecular markers, clinical trials or the latest research, and could provide consultation to the scientists who will be responsible for curating the diagnostic and treatment database 12.

The information in the diagnostic and treatment database 12 will be continually curated and updated so that the information provided is as up-to-date and relevant as possible to link molecular profiles, biomarker/molecular analysis data, therapeutic options, annotation, actual molecular testing of tumor tissue, disease, and demographic data.

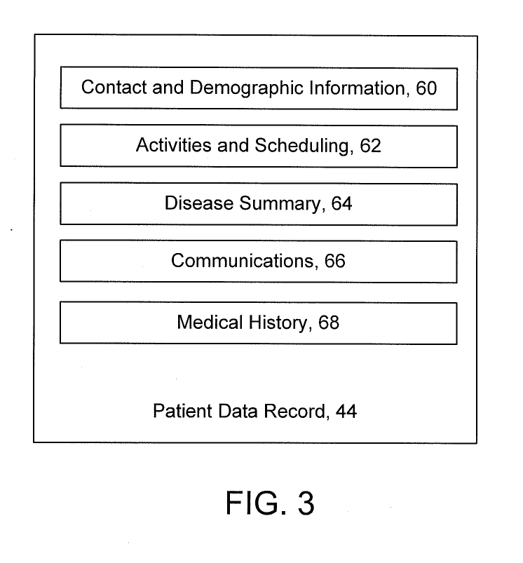

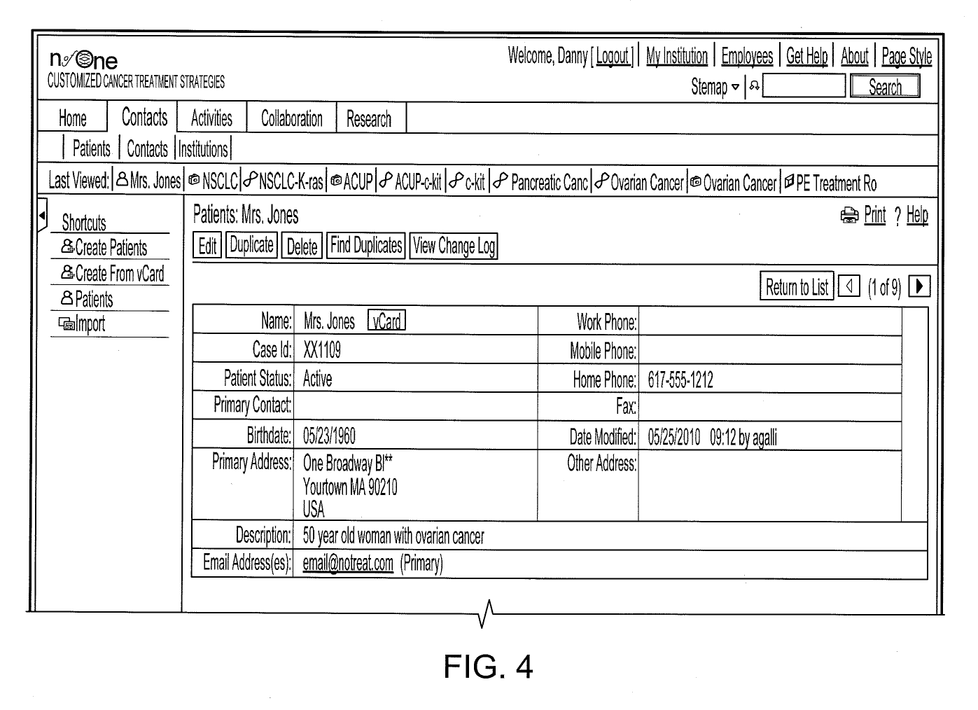

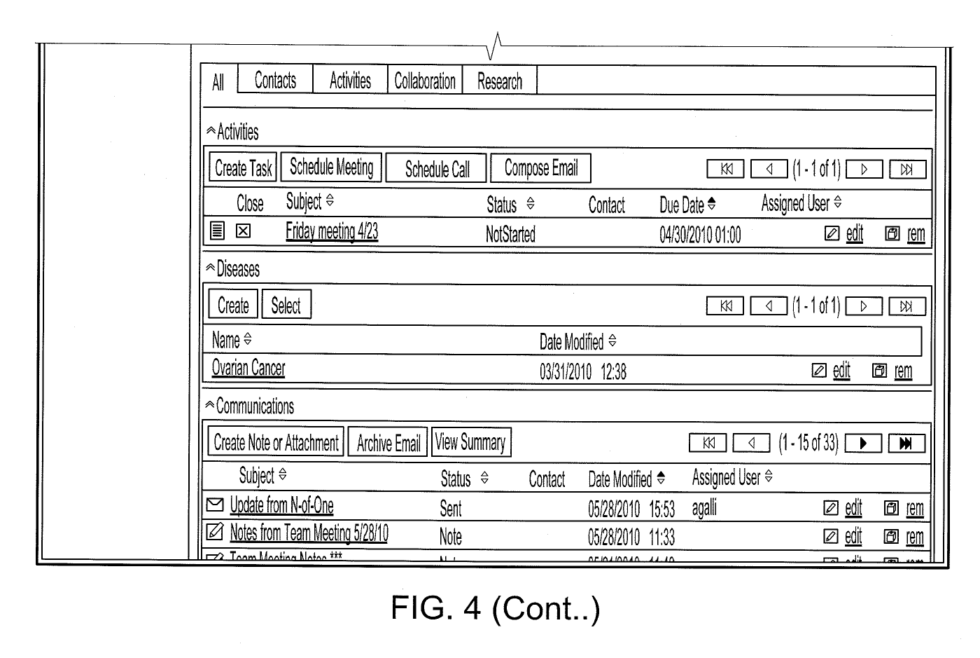

A central point of input will be the physician. In practice, the patient's physician, a subscriber to the diagnostic and treatment database 12, will enter the patient data 44. As shown in FIGS. 3 and 4, the patient data 44 can include a patient's demographic information 60, medical history 68, disease details 64 including treatment history and pathology information, and information about any activities/scheduling 62 and past communications 66. Medical documents, such as scans or pathology reports, could also be uploaded into the patient data 44. The patient data 44 can be linked to electronic medical records for ease of transfer of patient information including demographics, pathology reports, radiology reports and treatment history.

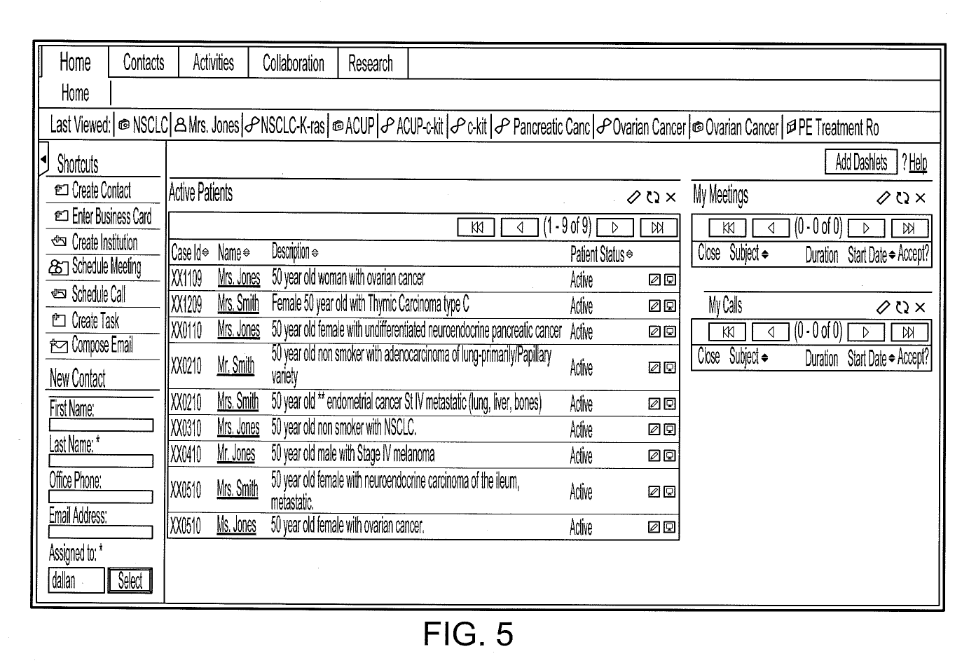

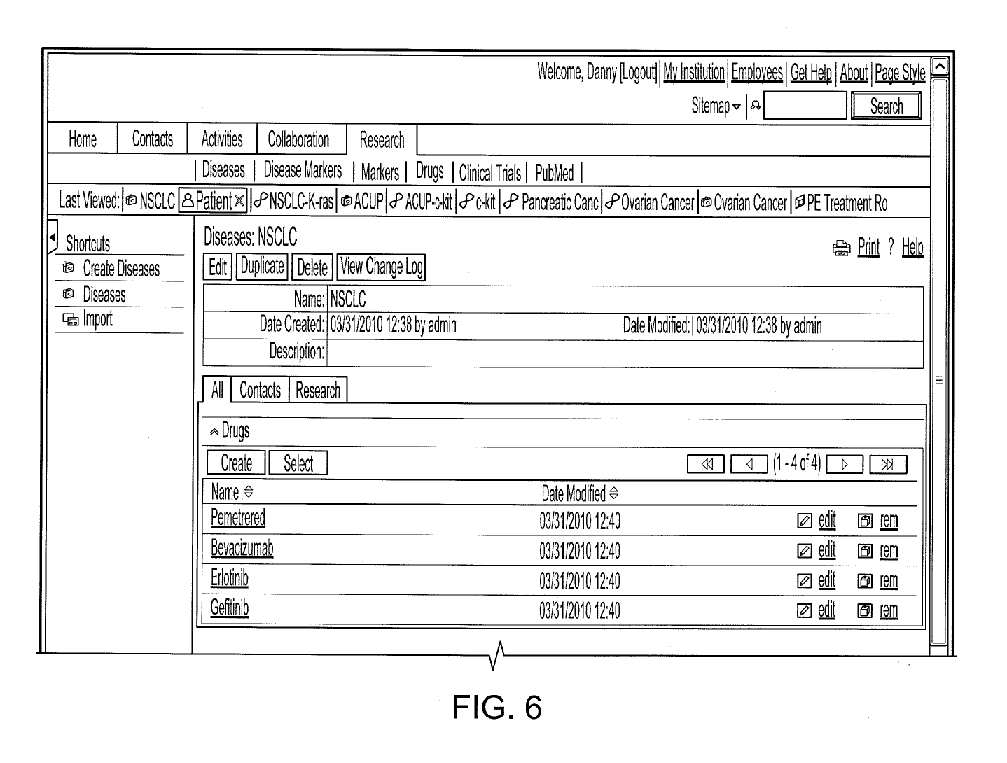

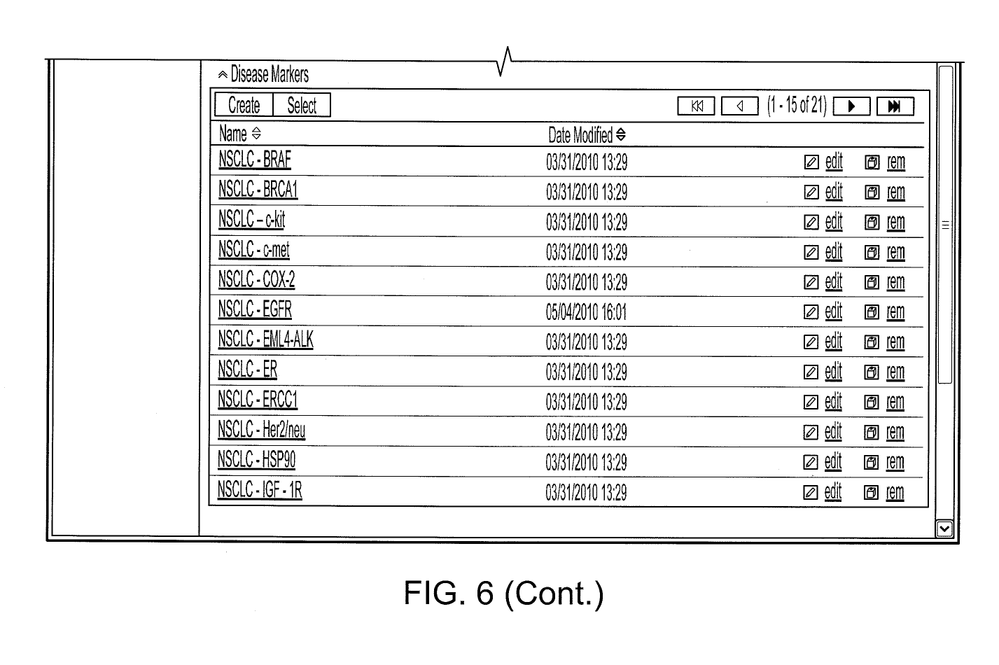

The patients themselves will also be able to subscribe to the diagnostic and treatment database 12 and access the database through a separate portal, allowing them to input relevant data which can be verified by a strategist. The patient/client will receive updates and relevant articles in addition to being able to view the status of their Diagnostic and treatment strategy roadmaps. Screen shots, showing the exemplary information layouts, are provided as FIGS. 4-6.

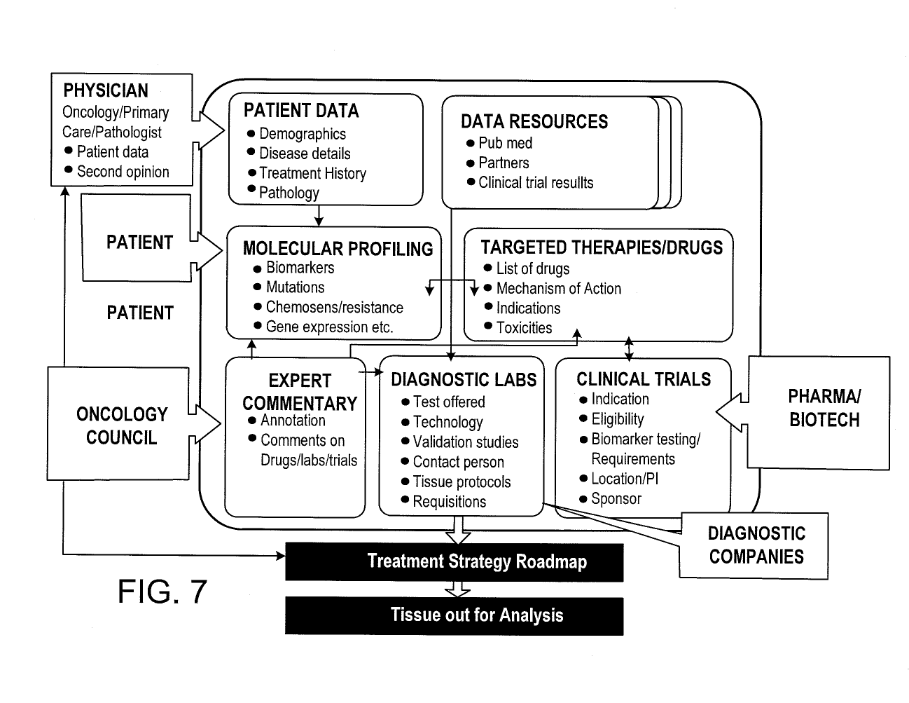

After entering the patient information 44 into the computer system 10, a subscribing physician could request a diagnostic strategy roadmap. The diagnostic strategy roadmap is generated by a diagnostic roadmap generation process 40 executed using the computer system 10. More particularly, the diagnostic strategy roadmap is automatically generated by the diagnostic roadmap generation process 40 and incorporates the patient's demographic information, disease type, medical and treatment history as entered by the treating physician. In some embodiments, the diagnostic strategy roadmap includes a list of biomarkers to test on the patient's tumor, includes the rationale and references for the testing, and provides a list of laboratories where the testing could be performed as well as detailed logistical information for expediting the testing (e.g., the tumor tissue form and quantity, packaging and shipping instructions, etc.). An overview of the interactions for generation of the diagnostic roadmap is shown in FIG. 7.

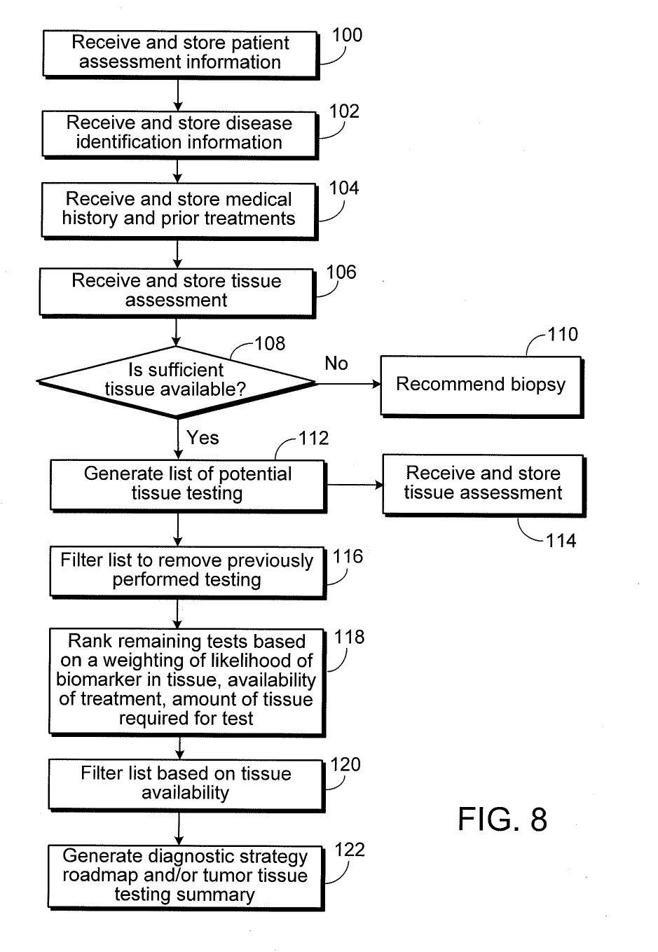

FIG. 8 shows an exemplary process for automatic generation of a diagnostic strategy roadmap by the diagnostic roadmap generation process 40 in computer system 10. The process is executed on a computer system.

At box 100, the computer system 10 receives and stores patient assessment information. The patient assessment can include information obtained from a manual review of medical records and/or can be obtained automatically by uploading information from a physician or hospital's electronic medical records.

At box 102, the computer system 10 receives and stores disease identification information. The disease information can include the patient's medical diagnosis such as the type and stage of the patient's cancer. The disease information can be entered into the database manually or can be obtained automatically by uploading information from a physician or hospital's electronic medical records.

At box 104, the computer system 10 receives and stores information related to a patient's medical history and prior treatments. The medical history and prior treatments information can be entered into the database manually or can be obtained automatically by uploading information from a physician or hospital's electronic medical records.

While not shown in the flow-chart of FIG. 8, at any point subsequent to receipt of the patient assessment information, disease identification information, and medical history information, the computer system can generate and output a standardized medical record and list of prior treatments. The standardized medical record and list of prior treatments can include a set of data selected by a physician for review. While the information is likely available from the patient's medical records, generating a medical record in a standardized form can allow a physician reviewing the file for the first time to do so more efficiently because the data would be placed in a similar format and location as in other summaries.

Returning to the process shown in FIG. 8, at box 106, the computer system 10 receives and stores tissue assessment information. The tissue assessment information includes information about tissue obtained from past biopsies that is available for analysis. For example, the tissue assessment information can include an amount of tissue available for analysis, the age of the sample, and/or the quality of the sample. The tissue assessment information is used by the system to determine potential tests to recommend be performed. For example, the system can limit the suggested tests to a number of tests that can be performed on the previously obtained tissue or can recommend performing an additional biopsy to obtain additional tissue samples if the quantity or quality of tissue is insufficient for testing.

At box 108, the computer system 10 determines if sufficient tissue available. The computer system 10 can determine whether sufficient tissue is available by comparing the quantity of tissue to a quantity threshold. In some additional examples, the system can include quality or age thresholds and can determine whether sufficient tissue available based on the quality or age thresholds. For example, tissue over 5 years old (or any set age) could be determined to be insufficient for further testing.

At box 110, if sufficient tissue is not available, the computer system sends an indication to the physician/patient recommending that a biopsy be performed by a physician to obtain tissue and at box 114, the computer system 10 receives and stores tissue assessment information from the biopsy. As noted above, the tissue assessment information can include an amount of tissue available for analysis, the age of the sample, and/or the quality of the sample.

At box 112, the computer system 10 generates list of potential tissue testing. The list of potential tissue testing is based on information in the diagnostic and treatment database 12 in combination with information about the disease type of the patient. More particularly, the computer system automatically retrieves information about the patient's disease type and identifies tests that are likely to lead to information that can help guide treatment based on the tumor type and biomarker. The potential tests are selected based on information about the incidence of a particular biomarker in a given tumor type, as well as the evidence for correlation between presence of the biomarker and response to a therapy. This information can be obtained, for example, from the medical literature and publically available databases (such as COSMIC).

At box 116, the computer system 10 filters the list of potential tissue testing to remove previously performed testing. For example, the system can automatically compare a list of tests included in the potential tissue testing to a list of tests previously performed for the patient and remove any of the previously performed tests. In some additional examples, the filtering can be more complex. For example, in addition to removing tests that are identical to previously performed tests, tests that are aimed at identifying the same type of results can be removed if a prior test indicated a negative result.

At box 118, the computer system 10 ranks remaining tests based on a weighting of likelihood of biomarker in tissue, availability of treatment, and amount of tissue required for test. For example, a test for a biomarker with a drug currently on the market can be given a higher priority than a drug in clinical trials. Additionally, a test that requires only a small amount of tissue may be given a higher priority than a test requiring a large tissue sample in order to allow a greater number of tests to be performed. Some broad tests may substitute for individual tests in the event that sufficient tissue is available. For example, a test that requires 20 slides to assay 50 genes may replace 3 tests that require 3 slides each to assay individual genes, if the tissue is sufficient. The ranking combines an assessment of the incidence of the biomarker in that tumor type (e.g., how often is that biomarker present in that tumor type) with the extent to which the result of the test can be directly applied to therapy (e.g., are there drugs on the market or in clinical trial that target the biomarker).

At box 120, the computer system 10 filters list based on tissue availability. More particularly, the tests included in the ranked list generated at box 118 would likely require more tissue than is available for testing. In order to determine tests to include in a final list of suggested tests, the amount of tissue can be used as a cut-off and any test in excess of the total available tissue amount can be excluded. If ample tissue is available, other factors can be used by the computer system to determine a cut-off for tests to include in the list of suggested tests. For example, tests with a low likelihood of identifying a biomarker that may lead to treatment options (e.g., a likelihood below a predetermined threshold) may be excluded.

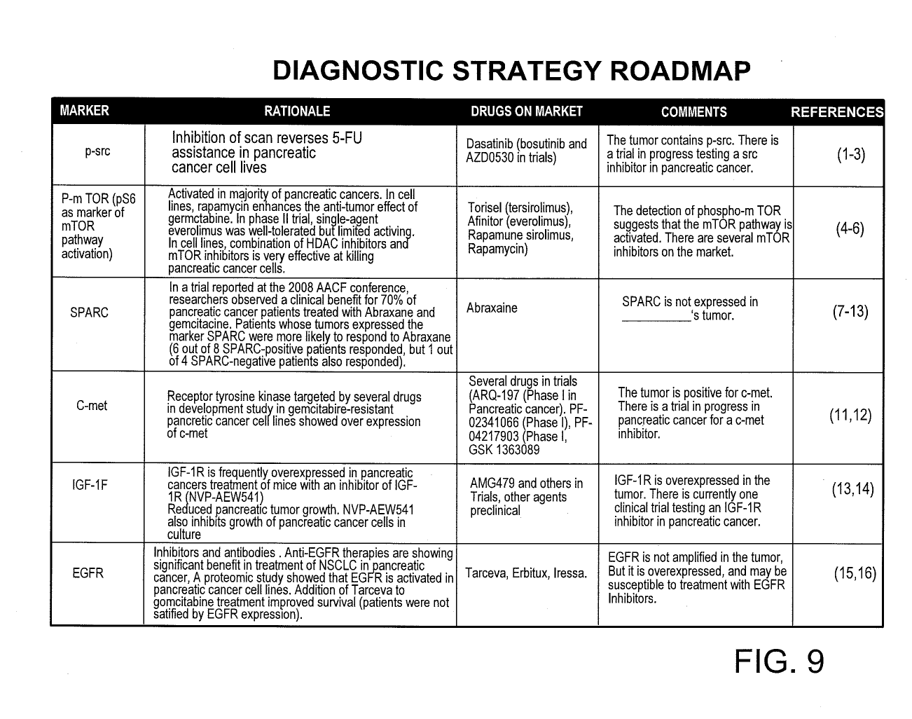

At box 122, the computer system 10 generates a diagnostic strategy roadmap and/or tumor tissue testing summary. In general, the diagnostic strategy roadmap provides a list of tests that are generated by the system based on the information about the patient and the information about biomarkers, testing, treatments, etc in the database (e.g., as described above). In addition to listing suggested testing, the diagnostic strategy roadmap includes a description of the biomarker that will be tested by the test and an explanation of the rationale for testing the biomarker. For example, the rationale can include information about what can be learned from a positive or negative result for the biomarker, information about drugs on the market, information about ongoing clinical trials, and the like. Additionally, in some examples, the diagnostic strategy roadmap can include a list of drugs on the market that might be suggested should a positive result be received for a particular biomarker. Including a listing of the drugs at the time of testing can help a physician to determine if the test is worthwhile based on other considerations for the patient. Additionally, the diagnostic strategy roadmap can include a list of references that support the information in the roadmap. For example, the physician and/or patient may desire to learn more about the biomarker, clinical studies, or other information about the biomarker before performing a particular test. By including this information in an easy to find manner (e.g., linked to the entry in the diagnostic strategy roadmap by a hyperlink), the patient and/or doctor can have easy access to the information. An exemplary diagnostic strategy roadmap is shown in FIG. 9.

Referring back to box 122 in FIG. 8, in addition to generating a diagnostic strategy roadmap, the process can also generate a tissue testing summary. The tissue testing summary can include a list of tests for the patient, high level rationale for performing the tests, the number of slides or amount of tissue required for the test, and how/where the test can be performed. The tissue testing summary can include links to additional information about each of the tests such as detailed information about the rationale for the test and/or references that provide information about the biomarker associated with the test. In some examples, the tissue testing summary can be linked to related portions of the diagnostic strategy roadmap (e.g., by a hyperlink) such that clicking on the test in the tissue testing summary hyperlinks the user to information about the test and associated biomarker in the diagnostic roadmap.

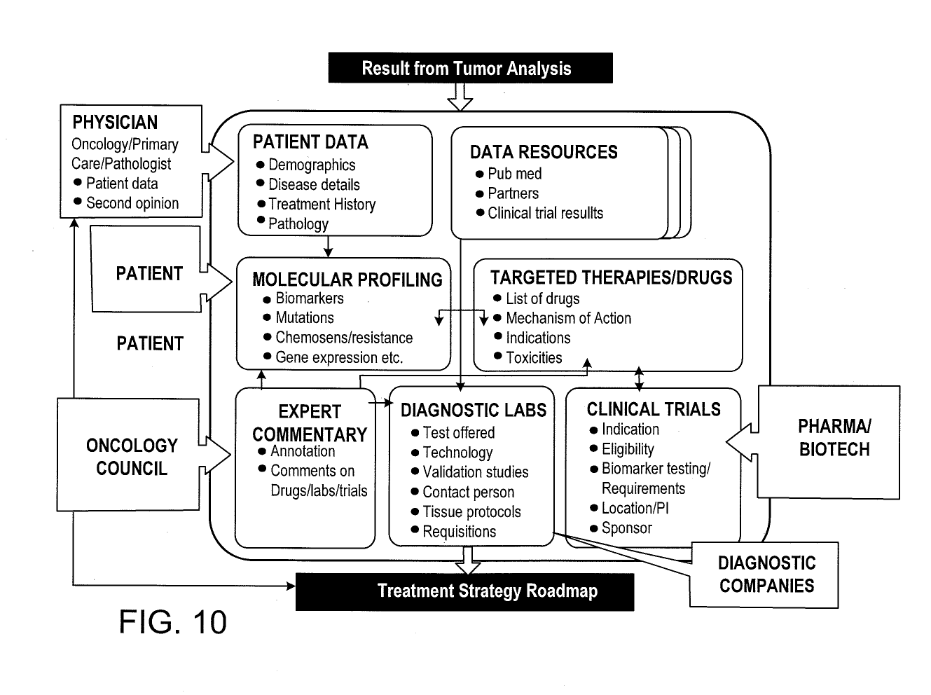

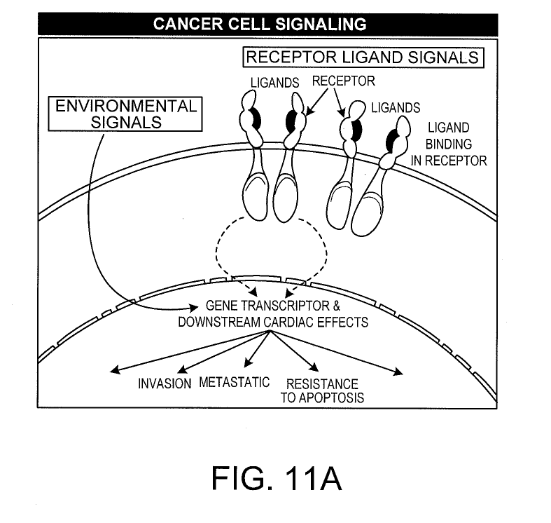

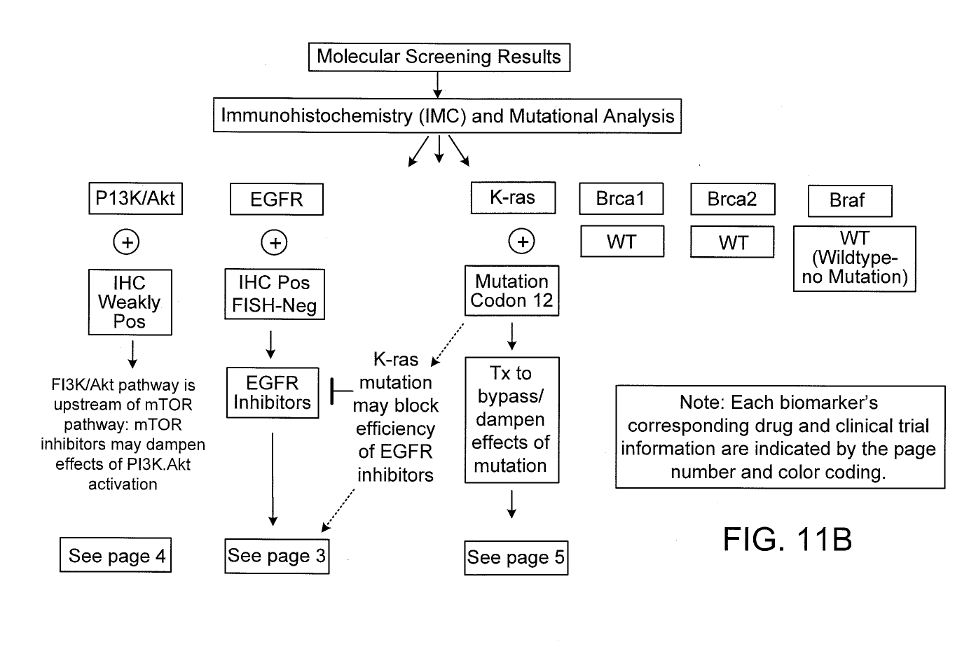

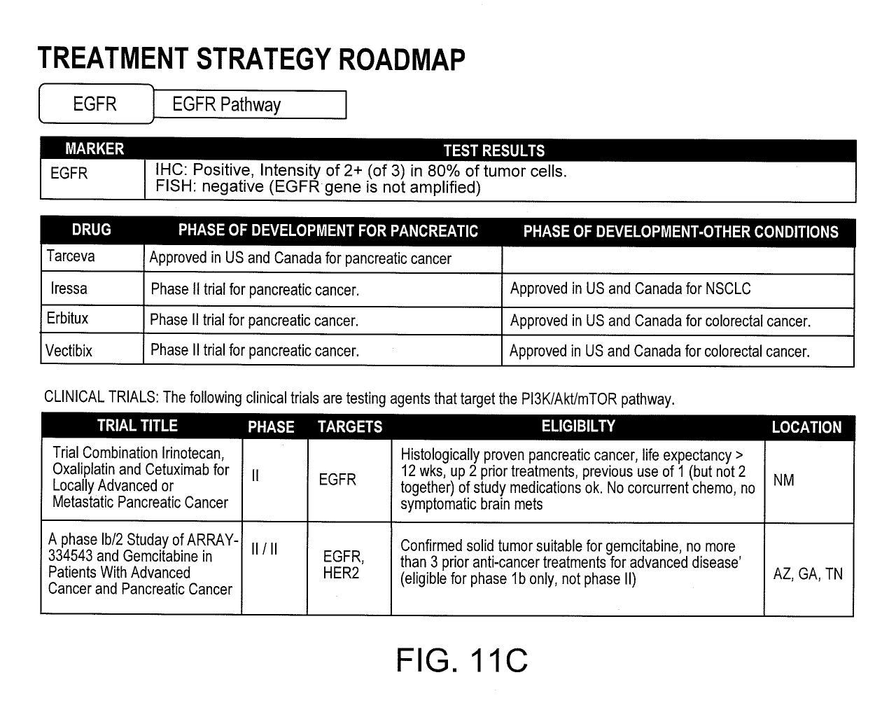

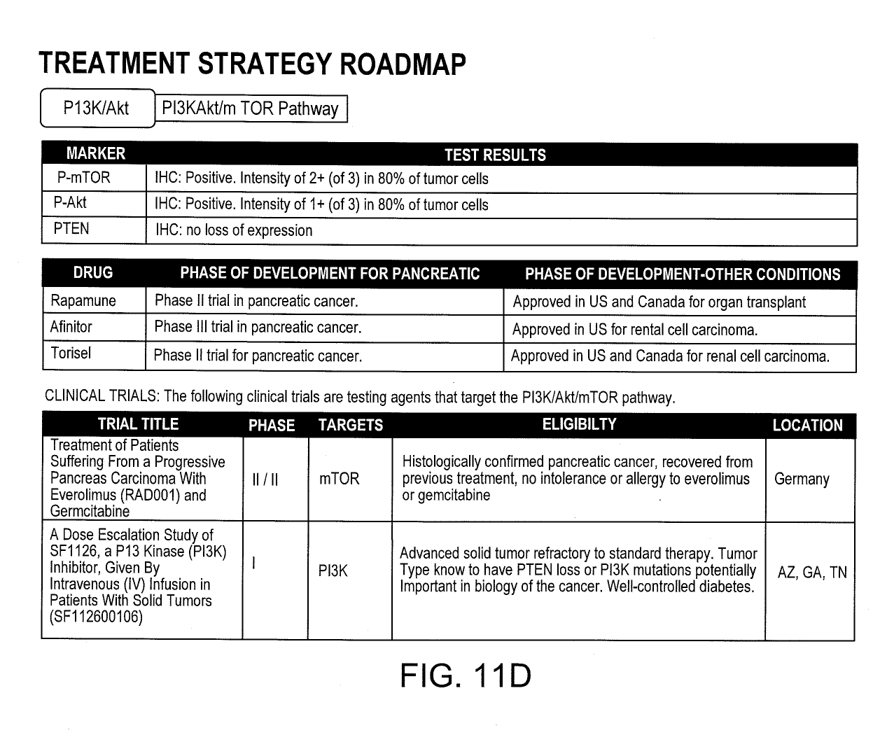

Upon completion of the diagnostic testing, results will be uploaded into the patient data 44 in the computer system 10 by a client services team member, the subscribing physician, or by the diagnostic testing laboratory itself. The physician and/or patient will then be able to request a treatment strategy roadmap which outlines treatment options and includes currently approved drugs and clinical trials that could be applicable given the patient's history and their tumor's molecular profile. An overview of the interactions for generation of the diagnostic roadmap is shown in FIG. 10 and an example of a treatment strategy roadmap is provided as FIGS. 11A-D.

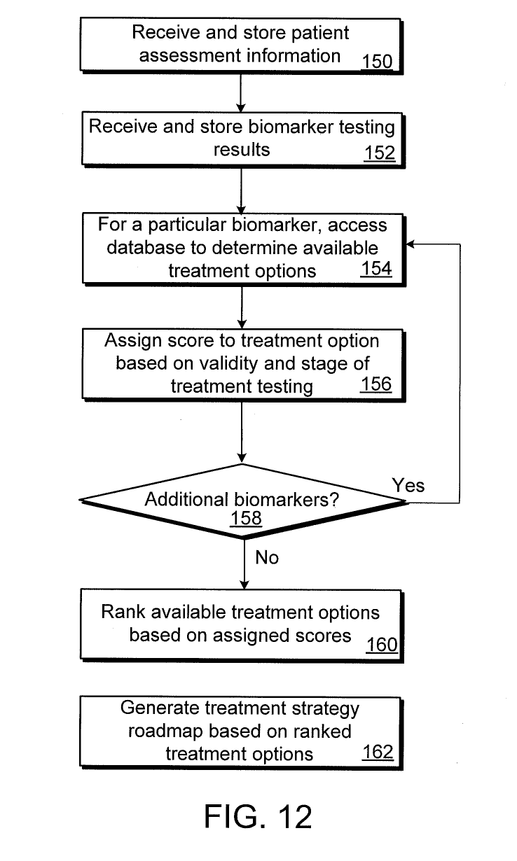

More particularly, FIG. 12 shows an exemplary process for automatic generation of a treatment strategy roadmap by the treatment roadmap generation process 42 in computer system 10. The process is executed on a computer system.

At box 150, the computer system receives and stores patient assessment information. In some examples, the patient assessment information may have been previously entered during generation of a diagnostic strategy roadmap. The patient assessment information can include information obtained from a manual review of medical records and/or can be obtained automatically by the computer system by uploading information from a physician or hospital's electronic medical records.

At box 152, the computer system receives and stores biomarker testing results. The biomarker results can include results from the testing suggested in a diagnostic strategy roadmap. The biomarker results can include information obtained from a manual review of diagnostic testing results and/or can be obtained automatically by uploading information from a physician or hospital's electronic medical records.

At box 154, for a particular biomarker, the computer system accesses the database to determine available treatment options. More particularly, for a particular biomarker with a positive result, the computer system accesses information related to that biomarker in the diagnostic and treatment database to determine if there are any drugs associated with the biomarker and to determine if there are any current clinical trials related to the biomarker. Thus, the computer system provides a centralized method for collecting and filtering large volumes of data about drugs (both on market and in clinical trials).

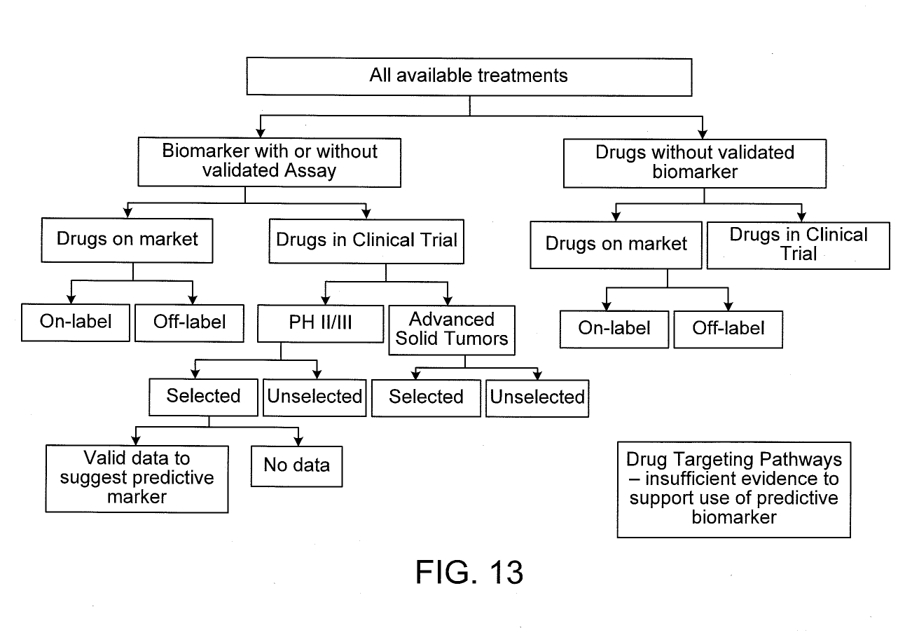

At box 156, the computer system assigns a score to treatment option based on validity and stage of treatment testing. The score for a particular treatment option can be based on the availability of a drug, the effectiveness of a treatment, and/or the stage of a clinical trial for a particular treatment. Thus, a higher score is assigned by the computer system for a drug that is on the market than for a drug in clinical trials. The scores can be used to help a physician review the available treatments and select a treatment that has the highest likelihood of being available and effective. In some examples, multiple treatment options will be available for a single biomarker. For example, there may be multiple drugs on the market or there may be both drugs on the market and ongoing clinical trials. FIG. 13 shows an exemplary decision tree for assigning scores to treatment options. In the decision tree shown in FIG. 13, the treatment options are sorted based on their availability, prior results, and other information on their effectiveness. Based on this information, the system automatically assigns a score to each treatment option such that treatment options toward the left of each main branch of the tree are given higher scores (and therefore higher priority) in the treatment strategy roadmap compared to treatments to the right on that branch of the tree. For example, the two main branches of the tree (“Biomarker with or without validated assay” and “Drugs without Validated Biomarker”) are essentially independent of each other. That is, a drug in an advanced solid tumor trial of unselected patients (even if there is a biomarker) would not be higher priority than a drug without a biomarker but that is on-label for a particular disease type. They would be evaluated in parallel. Each branch can be read from left to right in order of priority. For example, a biomarker with a drug available on the market “on label” (that is, in the indication for which it was approved) is given the highest score and priority. In another example, a drug in clinical trials for advanced solid tumors in which patients are “selected” by their biomarker status is given a higher priority than a drug in clinical trials for advanced solid tumors in which the patients are “unselected.” The information on which these decisions are based is stored in the relational database as fields in the drug and marker information. For example, each marker described in the database has a list of associated drugs, and the information about approval and clinical trials is stored within the record for each drug. Similarly, each drug record contains a list of markers with validated assays.

At box 158, the computer system determines if there are additional biomarkers to consider for treatment options. If there are additional biomarkers for which the patient received a positive result, the system returns to box 154 and accesses the database to determine available treatment options based on the biomarker.

At box 160, after treatment options based on each of the biomarkers have been determined, the computer system ranks the available treatment options based on assigned scores. For example, the computer system can generate a list of all available treatments (e.g., as determined by the preceding process) and sort the treatment options based on the scores for each of the treatment options. By ranking available treatments based on the different biomarkers, the physician can view a list of treatments in a ranked order based on availability and prior results. In other examples, the scores for the treatments can be used to rank the biomarkers and a treatment strategy roadmap can order the biomarkers based on the treatment options available for each biomarker (as an alternative to or in addition to ranking the treatments).

At box 162, the computer system generates a treatment strategy roadmap based on ranked treatment options. An example of a treatment strategy roadmap is provided in FIGS. 11A-D. In general, the treatment strategy roadmap includes a list of drugs that could be applicable for the patient, including information about whether or not they have been approved for the indication, the indications for which they are approved, and clinical trials that are in progress testing the drugs in the relevant indication. The Roadmap would also include data about outcomes using the drugs, based on information from the literature, from abstracts presented at scientific conferences, and from information shared directly by members of the Oncology Council who are experts in the field. The treatment strategy roadmap provides information about biomarkers for which the patient tested positive and information about treatment options based on those biomarkers. In some examples, the treatment strategy roadmap can include additional educational information to explain the biomarkers and/or the drugs to the physician/patient.

In the example shown in FIGS. 11A-D, in FIG. 11A, the treatment strategy roadmap includes an overview of the use of biomarkers and information about how biomarkers can be helpful in determining treatment options. This information can be beneficial to both a doctor and patient as screening for biomarkers and treatment based on biomarkers may not be commonly used so the patient may desire further information before determining a course of action. The treatment strategy roadmap also includes a summary of the biomarkers that were tested and the results of the testing (e.g., as shown in FIG. 11B). In addition to providing the results of the testing, the treatment strategy roadmap can link the biomarker test results to the available treatment options and further information about the biomarker (e.g., as shown in FIGS. 11C and 11 D) to allow the physician or patient to easily navigate the treatment strategy roadmap to understand available treatment options. For example, for each biomarker with a positive result, the treatment strategy roadmap can include a description of the biomarker and the test results, drugs on the market and their phase of development, and/or clinical trials that are testing drugs or treatments based on the biomarker.

In some embodiments, the patient treatment and outcome data will be entered into the diagnostic and treatment database 12 to enrich the collective data, and to provide valuable insights and validation of the model of linking molecular diagnostics to therapeutic strategies, and different therapeutic protocols.

In some embodiments, the diagnostic and treatment database 12 will also include a Personalized Medical Alerting Service, which will be designed to alert patients about various topics relevant to their diagnosis and treatment, for example: their potential eligibility for clinical trials, changes in approved treatments, expanded use of medications, and use of the information gained through molecular profiling of their biological samples. The process, in an embodiment, includes, but is not limited to, molecular profiling of tumor specimens from individual cancer patients and an automated alerting system that notifies individual patients about their eligibility for molecular targeted therapies that have been approved or are in clinical trials. Such an alerting system can include components and software known in the art but designed with specific unique features particular to the processes described herein, to provide the alerting protocol contemplated by the processes described herein.

Another component of the personalized medical advisory service can include an external network process. At present, no single organization can maintain all of the expertise required to provide patients with optimal individualized care strategies. However, the present system has been designed to provide a process for establishing a network of external medical and scientific thought leaders, and of leading-edge laboratories.

### EXAMPLE

This first phase entails the construction of a diagnostic strategy roadmap, outlining potential diagnostic testing that could inform the patient and his or her physician of possible treatment strategies specific for his or her own cancer. During this phase, the following steps would occur:

The subscribing physician would enter the patient's information into the diagnostic and treatment database 12. Entries would include disease type, medical history, treatment history, and all relevant information. This patient-related data can also be “pushed” directly from the electronic medical record into the database. The database will be able to interface with the range of different EMR platforms.

The physician would then be rapidly provided with an up-to-date diagnostic strategy roadmap. Because the diagnostic and treatment database 12 will be continually updated and curated, the physician will know that the information is current. The diagnostic strategy roadmap will include a list of molecular markers to be tested, with rationales for testing supported by references to the primary literature, and a list of laboratories where the testing could be performed. The diagnostic and treatment database 12 would contain information regarding the validity of all the laboratory tests, as well as logistical information on how to order testing; all this information would be readily available to a subscribing physician.

If the physician required assistance in facilitating tissue testing, strategists would be available to provide assistance.

Upon the completion of testing, the results could be uploaded directly to the diagnostic and treatment database 12 by the testing laboratory, or they could be sent to the patient's physician who could upload the results. The physician could then request a treatment strategy roadmap. This roadmap would also be automatically generated, reflecting the patient's history and results of diagnostic testing.

The treatment strategy roadmap would be based on the patient's molecular profile and other patient-specific information. The Roadmap would include a list of drugs that could be applicable for this patient, including information about whether or not they have been approved for the indication, the indications for which they are approved, reimbursement considerations, and clinical trials that are in progress testing the drugs in the relevant indication. The Roadmap would also include data about outcomes using the drugs, based on information from the literature, from abstracts presented at scientific conferences, and from information shared directly by members of the Oncology Council who are experts in the field.

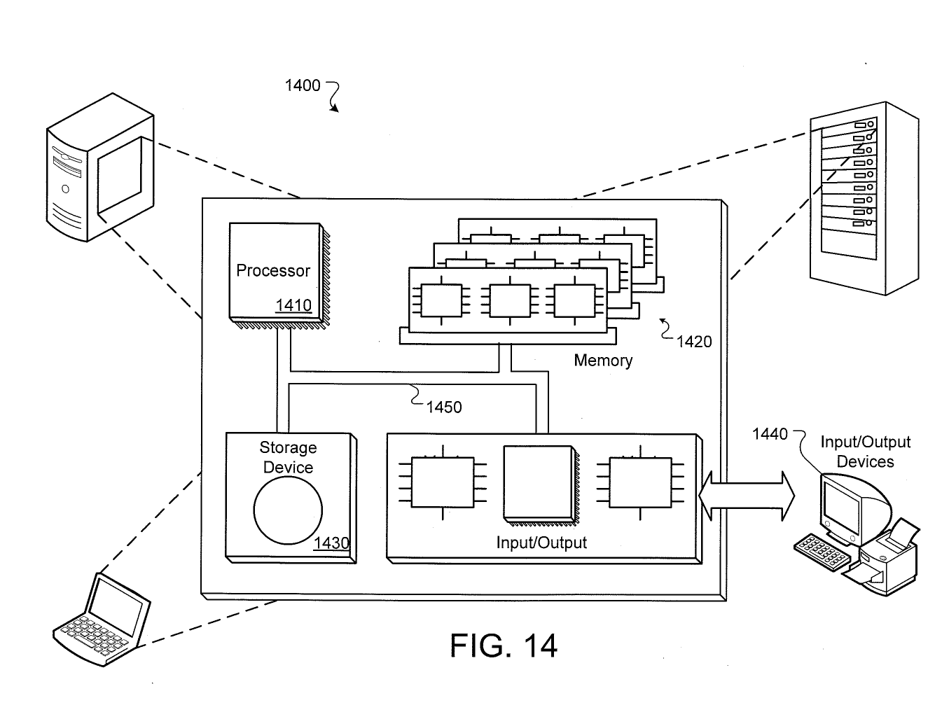

FIG. 14 is a schematic diagram of a computer system 1400. The system 1400 can be used for the operations described in association with any of the computer-implement methods described previously, according to one implementation. The system 1400 is intended to include various forms of digital computers, such as laptops, desktops, workstations, personal digital assistants, servers, blade servers, mainframes, and other appropriate computers. The system 1400 can also include mobile devices, such as personal digital assistants, cellular telephones, smartphones, and other similar computing devices. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The system 1400 includes a processor 1410, a memory 1420, a storage device 1430, and an input/output device 1440. Each of the components 1410, 1420, 1430, and 1440 are interconnected using a system bus 1450. The processor 1410 is capable of processing instructions for execution within the system 1400. The processor may be designed using any of a number of architectures. For example, the processor 1410 may be a CISC (Complex Instruction Set Computers) processor, a RISC (Reduced Instruction Set Computer) processor, or a MISC (Minimal Instruction Set Computer) processor.

In one implementation, the processor 1410 is a single-threaded processor. In another implementation, the processor 1410 is a multi-threaded processor. The processor 1410 is capable of processing instructions stored in the memory 1420 or on the storage device 1430 to display graphical information for a user interface on the input/output device 1440.

The memory 1420 stores information within the system 1400. In one implementation, the memory 1420 is a computer-readable medium. In one implementation, the memory 1420 is a volatile memory unit. In another implementation, the memory 1420 is a non-volatile memory unit.

The storage device 1430 is capable of providing mass storage for the system 1400. In one implementation, the storage device 1430 is a computer-readable medium. In various different implementations, the storage device 1430 may be a floppy disk device, a hard disk device, an optical disk device, or a tape device.

The input/output device 1440 provides input/output operations for the system 1400. In one implementation, the input/output device 1440 includes a keyboard and/or pointing device. In another implementation, the input/output device 1440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

The computer system can include clients and servers. A client and server are generally remote from each other and typically interact through a network, such as the described one. The relationship of client and server arises by virtue of computer programs running on the respective computers and having a client-server relationship to each other.

While the present invention has been described with reference to certain embodiments thereof, it should be understood by those skilled in the art that various changes may be made and equivalents may be substituted without departing from the true spirit and scope of this invention. In addition, many modifications may be made to adapt to a particular situation, indication, material and composition of matter, process step or steps, without departing from the spirit and scope of the present invention. All such modifications are intended to be within the scope of the disclosure of the present invention.

What is claimed is:

1. A computer-implemented method comprising:
receiving, by one or more computers, patient information including disease identification information;
receiving, by the one or more computers, tissue assessment information related to tissue available for testing;
accessing, by the one or more computers, a database that includes information related to biomarkers and tissue testing to generate a set of potential diagnostic tests, the set of potential diagnostic tests being based in part on the disease identification information; and
providing information related to at least some of the potential diagnostic tests in the set of potential diagnostic tests to a user.

2. The method of claim 1, further comprising:
receiving, by the one or more computers, information based on biomarker testing results;
accessing, by the one or more computers, a database that includes information related to drugs, clinical studies, and other treatment options associated with biomarker information to generate a set of treatment options; and
providing information related to at least some of the treatment options in the set of treatment options to a user.

3. The method of claim 1, further comprising:
ranking, by the one or more computers, the set of potential diagnostic tests based on one or more of a likelihood of a biomarker associated with a particular diagnostic test being present in tissue, availability of treatment based on biomarker associated with the particular diagnostic test, and an amount of tissue required for the particular diagnostic test.

4. The method of claim 3, further comprising:
filtering, by the one or more computers, the set of potential diagnostic tests based on the ranking.

5. The method of claim 4, wherein filtering the set of potential diagnostic tests comprises filtering the set of potential diagnostic tests based on the tissue assessment information and providing information related to at least some of the potential diagnostic tests to the user comprises providing the filtered set of potential diagnostic tests.

6. The method of claim 1, wherein providing information related to at least some of the potential diagnostic tests to the user comprises generating a diagnostic strategy roadmap.

7. The method of claim 1, wherein providing information related to at least some of the potential diagnostic tests comprises providing a list of suggested diagnostic tests, an explanation of the rationale for testing a biomarker, a list of drugs for a particular biomarker, and a list of references related to a biomarker.

8. A system comprising:
a database configured to store patient information including disease identification information and tissue assessment information related to tissue available for testing;
one or more computers configured to:
access the database that includes information related to biomarkers and tissue testing to generate a set of potential diagnostic tests, the set of potential diagnostic tests being based in part on the disease identification information; and
provide information related to at least some of the potential diagnostic tests in the set of potential diagnostic tests to a user.

9. The system of claim 8, wherein the one or more computers are further configured to:
rank the set of potential diagnostic tests based on one or more of a likelihood of a biomarker associated with a particular diagnostic test being present in tissue, availability of treatment based on biomarker associated with the particular diagnostic test, and an amount of tissue required for the particular diagnostic test; and
filter the set of potential diagnostic tests based on the ranking.

10. The system of claim 9, wherein the configurations to filter the set of potential diagnostic tests comprise configurations to filter the set of potential diagnostic tests based on the tissue assessment information and the configurations to provide information related to at least some of the potential diagnostic tests to the user comprise configurations to provide the filtered set of potential diagnostic tests.

11. The system of claim 1, wherein the configurations to provide information related to at least some of the potential diagnostic tests to the user comprise configurations to generate a diagnostic strategy roadmap.

12. A computer-implemented method comprising:
receiving, by one or more computers, patient information including disease identification information;
receiving, by the one or more computers, information based on biomarker testing results;
accessing, by the one or more computers, a database that includes information related to drugs, clinical studies, and other treatment options associated with biomarker information to generate a set of treatment options; and
providing information related to at least some of the treatment options in the set of treatment options to a user.

13. The method of claim 12, further comprising:
for each of the treatment options in the set of treatment options, assigning, by the one or more computers, a score associated with a validity and stage of testing of the treatment; and
ranking, by the one or more computers, the treatment options in the set of treatment options based on the assigned scores.

14. The method of claim 12, wherein providing information related to at least some of the treatment options comprises generating a treatment strategy roadmap.

15. The method of claim 12, wherein information related to at least some of the treatment options comprises information associated with currently approved drugs and clinical trials based on a molecular profile of a tumor in the patient.

16. The method of claim 12, wherein providing information related to at least some of the treatment options comprises providing information related to available drugs associated with a biomarker and ongoing clinical studies associated with the biomarker.

17. A system comprising:
a first database configured to store patient information including disease identification information and information based on biomarker testing results; a second database that includes information related to drugs, clinical studies, and other treatment options associated with biomarker information to generate a set of treatment options; and
one or more computers configured to:
access the database that includes information related to drugs, clinical studies, and other treatment options associated with biomarker information to generate a set of treatment options based on one or more of the patient information and the information based on biomarker testing results; and
provide information related to at least some of the treatment options in the set of treatment options to a user.

18. The system of claim 17, wherein the one or more computers are further configured to:
for each of the treatment options in the set of treatment options, assign, by the one or more computers, a score associated with a validity and stage of testing of the treatment; and
rank the treatment options in the set of treatment options based on the assigned scores.

19. The system of claim 17, wherein the configurations to provide information related to at least some of the treatment options comprise configurations to generate a treatment strategy roadmap.

20. The system of claim 17, wherein information related to at least some of the treatment options comprises information associated with currently approved drugs and clinical trials based on a molecular profile of a tumor in the patient.

21. The system of claim 17, wherein:
the database is further configured to store tissue assessment information related to tissue available for testing; and
the one or more computers are further configured to:
access the database that includes information related to biomarkers and tissue testing to generate a set of potential diagnostic tests, the set of potential diagnostic tests being based in part on the disease identification information; and
provide information related to at least some of the potential diagnostic tests in the set of potential diagnostic tests to a user.
